(19) United States
(12) Patent Application Publication
(10) Pub. No.: US 2013/0286237 A1
(43) Pub. Date: Oct. 31, 2013

(54) SPATIALLY MODULATED IMAGE INFORMATION RECONSTRUCTION

(71) Applicants: Ramin Samadani, Palo Alto, CA (US); Andrew J. Patti, Cupertino, CA (US)

(72) Inventors: Ramin Samadani, Palo Alto, CA (US); Andrew J. Patti, Cupertino, CA (US)

(21) Appl. No.: 13/459,527

(22) Filed: Apr. 30, 2012

(51) Int. Cl. H04N 9/04

(52) U.S. Cl. 348/222.1; 348/E09.002

(57) ABSTRACT

A system and method include a color filter array configured to spatially modulate captured image information and a processor configured to reconstruct the image information.

### BACKGROUND

Hyperspectral imagers record energy in many discrete spectral bands simultaneously over an array of pixels. To capture and reproduce spectral images, some known devices use spatially multiplexed narrow spectral bandwidth color filters and combine the outputs at low spatial resolution to reconstruct the spectral images or subsequently integrate the spectral information to reconstruct low resolution color images. The multiplexing in typical spectral capture can substantially reduce the spatial or temporal resolution of the captured image. The reduction of spatial resolution, for example, then requires interpolation to recover higher resolution spatial information. The interpolation limits the resolution of the reconstructed color images.

### BRIEF DESCRIPTION OF THE DRAWINGS

FIG. 1 is a block diagram illustrating an example of an image processing system.

FIG. 2 is a block diagram illustrating examples of further aspects of the system shown in FIG. 1.

FIG. 3 is a flow diagram illustrating an example of a method for reconstructing captured image information.

FIGS. 4A-4C illustrate spectral responses for example color filters.

FIG. 5 is a flow diagram illustrating an example of a method for reconstructing captured image information.

FIG. 6 conceptually illustrates an example of a color filter array.

FIG. 7 is a flow diagram illustrating an example of a further method for reconstructing captured image information.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various embodiments described herein may be combined with each other, unless specifically noted otherwise.

In the following disclosure, specific details may be set forth in order to provide a thorough understanding of the disclosed systems and methods. It should be understood however, that all of these specific details may not be required in every implementation. In other instances, well-known methods, procedures, components, circuits, and networks have not been described in detail so as not to unnecessarily obscure the disclosed systems and methods.

It will also be understood that, although the terms first, second, etc. are used herein to describe various elements, these elements should not be limited by these terms. These terms are only used to distinguish one element from another.

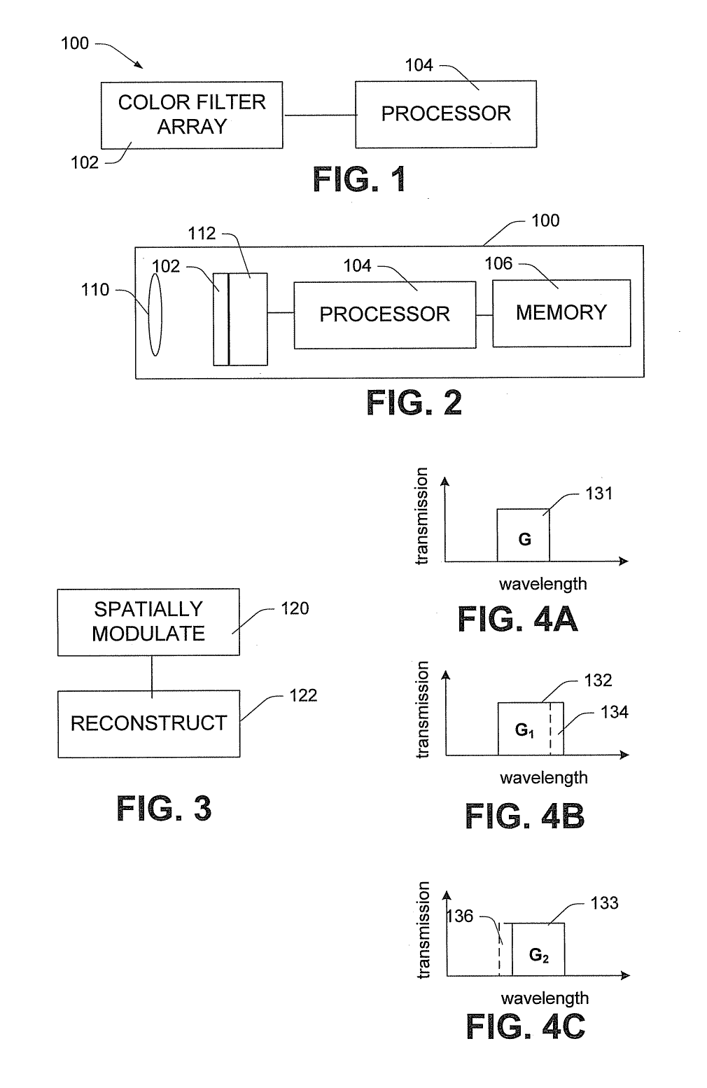

FIG. 1 illustrates an example of an imaging system 100 in accordance with the present disclosure. In general, embodiments of the imaging system 100 may be implemented in any one of a wide variety of electronic devices such as a camera or other device having a camera including various computers, video recording devices, mobile telephones, etc. The imaging system 100 generally includes a color filter array 102 configured to spatially modulate a captured image and a processor 104 configured to reconstruct the image.

FIG. 2 conceptually illustrates an implementation of the imaging system 100, wherein the system includes a lens 110 and a sensor 112 with the color filter array 102 situated on or adjacent the sensor 112. The processor 104 is coupled to receive an output signal from the sensor 112. A memory 106 is accessible by the processor 104. The captured image information may be stored in the memory 106. Additionally, software code embodying disclosed methods may be stored in the memory 106 or another tangible storage medium that is accessible by the processor 104. Storage media suitable for tangibly embodying program instructions and image data include all forms of computer-readable memory, including, for example, RAM, semiconductor memory devices, such as EPROM, EEPROM, and flash memory devices, magnetic disks such as internal hard disks and removable hard disks, magneto-optical disks, DVD-ROM/RAM, and CD-ROM/RAM.

An image of passing through the lens 110 passes through the color filter array 102 and is acquired in the form of light field information at the sensor 112. The sensor 112 includes a plurality of pixels that receive the light field information. Examples of suitable sensors include CMOS image sensors and charge-coupled device image sensors. The processor 104 is any suitable computing or data processing device, including a microprocessor, an application-specific integrated circuit (ASIC), a digital signal processor (DSP)), etc.

The color filter array 102 includes a plurality of color filters situated over pixels of the sensor 112 to capture color information of the captured image. The color filters filter the received light by wavelength range, such that the separate filtered intensities include information about the color of received light. For example, a standard Bayer filter gives information about the intensity of light in red, green, and blue (RGB) wavelength regions. The raw image data captured by the image sensor 112 is converted to a full-color image by a demosaicing algorithm for the particular type of color filter.

The color filter array 102 is configured to spatially modulate the color information of the captured image in such a way that the system 100 can provide both low spatial resolution spectral capture, while preserving high resolution color capture. Prior systems substantially reduce the spatial resolution of the capture to allow imaging spectroscopy. The reduction of spatial resolution then requires interpolation to recover higher resolution spatial information. The interpolation limits the resolution of the reconstructed color images.

The disclosed system 100 provides high spatial color capture, and also provides low resolution spectral capture. FIG. 3 broadly illustrates a method implemented by the system 100, wherein in block 120 the spectral response of an image captured using a broadband color filter is spatially modulated, and in block 122 the captured image information is reconstructed.

As noted above, the color filter array 102 is configured to spatially modulate its spectral response. The sensor pixels thus each have slightly different spectral responses. FIGS. 4A-4C conceptually illustrate one color channel of the color filter array 102. The three examples of the filter responses in FIGS. 4A-4C are shown as a block filter “square” response for ease of illustration and discussion. The illustrated filter is configured for a wavelength range corresponding to one color in the color filter array 102. In the example illustrated in FIG. 4, the color filter array 102 is an RGB filter array, with the spectral responses of portions of the green color channel illustrated. In FIG. 4A, the response of a first, or “base” green filter 131 is illustrated. Additional green filters are provided in the color filter array 102 having filter responses with different minimum and/or maximum wavelength values. For example, FIG. 4B illustrates a second green filter 132 that is configured for a second wavelength range, though still corresponding to green, but with the maximum wavelength value increased so the wavelength range is larger than the wavelength range of the first filter 131. FIG. 4C illustrates a third filter 133 configured for another wavelength range, but still corresponding to green. The green filter 133 has a wavelength range that is approximately the same as the first wavelength range of the first green filter 131, though it is shifted towards a longer wavelength and thus has different minimum and maximum wavelength values. FIGS. 4A-4C illustrate examples of only three filters. The color filter array 102 of course includes many filters configured to each capture slightly different wavelengths, and the particular captured wavelengths captured change with spatial location.

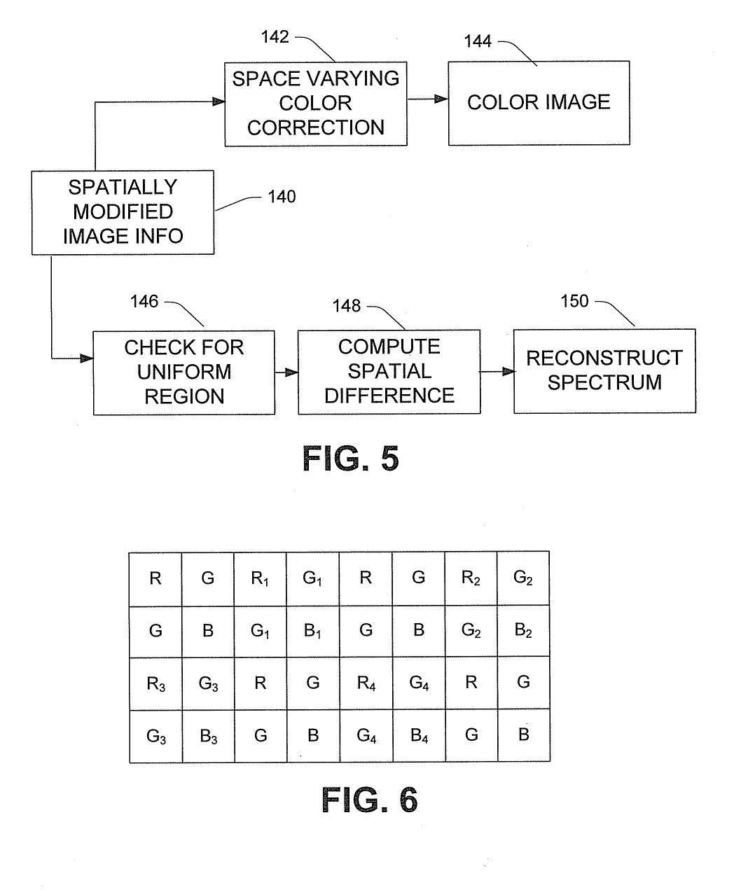

FIG. 5 illustrates examples of further aspects of the method shown in FIG. 3. FIG. 5 illustrates two paths for reconstructing the captured image information 140. The top path (blocks 142,144) illustrates reconstructing color information, which includes a high resolution RBG color image in some implementations. The lower path (blocks 146,148,150) illustrates reconstructing the spectra response of the image.

Since the filters are all broadband, and they change slowly in spectral response with spatial position, the captured modified RGB image 140 already has high spatial resolution. Pixel adaptive color correction 142 reconstructs the modified RGB colors from the known, spatially varying spectral responses of the color filters. The varying wavelength ranges such as the green filters 131,132,133 illustrated in the example of FIG. 4 are known, so this can be accounted for in a pre-calibration process. In this manner, the broadband RGB color information is captured, allowing reconstruction of the high resolution RGB image in block 144.

The lower path illustrated in FIG. 5 (blocks 146,148,150) checks that a uniform area is captured for spectral processing in block 146, and declares error if non-uniformity is detected. This process is not implemented in all embodiments, though for the spectral reconstruction process it is assumed that spectra of a homogeneous region of the image is desired. In block 148, differences of measurements from neighboring pixels are computed, providing spectral response information for narrow spectral slices.

As noted above, the example green filters 131,132,133 illustrated in FIGS. 4A-4C each have a slightly different spectral response. Subtracting the measurement of the first green filter 131 from the second green filter 132 (G₁-G) results in a narrow slice 134 of the spectrum shown in FIG. 4B. Similarly, subtracting the measurement of the third green filter 133 from the second green filter 132 (G₁-G₂) results in the narrow slice 136 of the spectrum shown in FIG. 4C. Thus, by shifting slightly the spectrum of some of the filters and slightly broadening the spectrum of some of the filters, a high resolution spectrum can be reconstructed using simple subtraction as long as the relevant portion of the captured image information is a uniform color.

In block 150 of FIG. 5, the computed slices of spectrum are combined (normalized in gain and blended) into a final reconstructed spectrum. The RGB color reconstruction (blocks 142,144) and the spectral reconstruction (blocks 146-150) can be conducted independently. For example, if the system 100 is implemented in a camera, the camera may have a user interface that allows a user to select a spectral mode used to capture spectra from single surfaces.

FIG. 6 illustrates a portion of an example of a color filter array 102 using spatially modulated broadband color filters such as the filters 131-133 of FIG. 4. The color filter array 102 shown in FIG. 6 includes standard Bayer filter patterns (RGGB) next to filters (RᵢGᵢGᵢBᵢ) that have their spatial position and/or wavelength range slightly changed, facilitating the spectral reconstruction described above. Other color filter patterns could be used in alternative implementations, including cyan, yellow, magenta (CYYM) filters, cyan, yellow, green, magenta (CYGM) filters, panchromatic filters, etc. with the color filters spatially varied as disclosed herein.

Using a color filter array such as illustrated in FIG. 6, the RGB color information can be reconstructed in multiple ways. For example, if the desired amount of resolution is present, the “modified” filters (RᵢGᵢGᵢBᵢ) can be disregarded and the RGB information from the remaining filters (RGGB) can be used to reconstruct the RGB image using standard demosaicing algorithms.

If additional resolution is desired, a demosaicing algorithm is used to reconstruct the RBB color information from the modified filters (RᵢGᵢGᵢBᵢ). For example, space weighting factors can be applied that combine a standard demosaic with a modified demosaic based on the space varying actual filter responses. This linear combination could be done in a linear fashion.

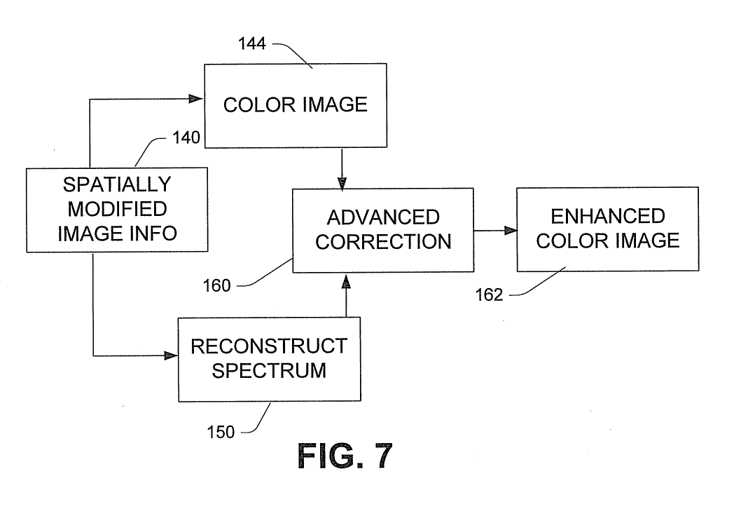

Joint processing of the captured color and spectral information allows for advanced enhancement of the color images in some implementations. FIG. 7 is a block diagram illustrating an example of such a process. The reconstructed RGB color image 144 and the reconstructed spectrum 150 shown in FIG. 5 are both applied to an advanced correction block 160. Both the reconstructed color information and spectrum information are then used to produce an enhanced color image in block 162.

For instance, the reconstructed spectral information 150 can be used to enhance the reconstructed color image 144. Even from non-uniform color regions of the captured image the spectral capture may still allow determination of the illuminant type, and this information can be subsequently used to correct the image white balance. In another example, skin spectral information is captured first, then an RGB image is subsequently captured color corrected for the specific skin characteristics.

Thus, various implementations of the disclosed system and methods provide low resolution spectral capture providing capabilities such as accurate colorimetry, illuminant identification and material classification while further providing high resolution color images. Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system, comprising:
a color filter array configured to spatially modulate captured image information; and
a processor configured to reconstruct the image information.

2. The system of claim 1, wherein:
the color filter array includes a first filter configured for a first wavelength range corresponding to a first color and a second color filter configured for a second wavelength range corresponding to the first color, the second wavelength range being larger than the first wavelength range; and
the processor is configured to calculate a difference of the spectral responses of the first and second color filters.

3. The system of claim 2, wherein:
the color filter array includes a third color filter configured for a third wavelength range corresponding to the first color, the third wavelength range being approximately the same as the first wavelength range and having different minimum and maximum wavelength values.
the processor is configured to calculate a difference of the spectral responses of the second and third color filters.

4. A method, comprising:
spatially modulating a spectral response of image information captured using a broadband color filter array;
reconstructing the image information by a processor.

5. The method of claim 4, wherein reconstructing the image information includes reconstructing an RGB color image.

6. The method of claim 4, wherein reconstructing the image information includes reconstructing spectral information of the image.

7. The method of claim 4, wherein spatially modulating the spectral response includes varying spectral responses of color filters in the color filter array.

8. The method of claim 7, wherein varying the spectral responses includes shifting the spectrum of predetermined color filters in the color filter array.

9. The method of claim 7, wherein varying the spectral responses includes broadening the spectrum predetermined color filters in the color filter array.

10. The method of claim 4, wherein reconstructing the image information includes determining a difference between a spectral responses of a first pixel of the color filter array and a second pixel of the color filter array.

11. The method of claim 4, wherein reconstructing the image information includes reconstructing an RGB color image and reconstructing spectral information of the image.

12. The method of claim 11, wherein reconstructing the image information includes enhancing the reconstructed RGB color image based on the reconstructed spectral information.

13. The method of claim 7, wherein varying the spectral responses includes shifting the spectrum of a second group of color filters as compared to a first group of color filters in the color filter array, and broadening the spectrum a third group of color filters in the color filter array as compared to the first group of color filters.

14. The method of claim 13, wherein reconstructing the image information includes reconstructing an RGB color image using color information captured from the first, second and third groups of filters.

15. The method of claim 13, wherein reconstructing the image information includes reconstructing an RGB color image using color information captured from only the first group of filters.

16. A device including a color filter array, comprising:
a first filter configured for a first wavelength range corresponding to a first color; and
a second color filter configured for a second wavelength range corresponding to the first color.

17. The device of claim 16, wherein at least one of a minimum and maximum wavelength value of the second wavelength range is different than the first wavelength range.

18. The device of claim 17, wherein the second wavelength range is larger than the first wavelength range.

19. The device of claim 16, further comprising a processor configured to calculate a difference of the spectral responses of the first and second color filters to reconstruct a spectrum of a captured image.

20. The device of claim 16, further comprising:
a third color filter; and
a processor configured to reconstruct a color image from image information captured using the first, second and third color filters; wherein
the second wavelength range is larger than the first wavelength range; and
the third color filter is configured for a third wavelength range corresponding to the first color, the third wavelength range being approximately the same as the first wavelength range and having different minimum and maximum wavelength values.
